(19) United States
(12) Patent Application Publication
(10) Pub. No.: US 2012/0328801 A1
(43) Pub. Date: Dec. 27, 2012

(54) Inflatable Decorative System

(76) Inventor: Kyle Robert Horn, Ames, IA (US)

(21) Appl. No.: 13/534,926

(22) Filed: Jun. 27, 2012

Related U.S. Application Data
(60) Provisional application No. 61/501,565, filed on Jun. 27, 2011.

(51) Int. Cl. B32B 1/04; A47C 4/54; A47B 3/00; A45F 3/00

(52) U.S. Cl. 428/12

(57) ABSTRACT

An inflatable decorative system that includes a vehicle that has an exhaust conduit that conveys exhaust from the vehicle. A coupling device couples an exhaust conveyance element sealingly to an exhaust conduit such that exhaust is conveyed from the first end of the exhaust conveyance element to the second end where the second end dispels the exhaust into an inflatable decorative receptacle. The inflatable decorative receptacle has indicia of individual's favorite sports teams to present a giant inflatable receptacle representing that individual's sports team.

### CROSS REFERENCE TO RELATED APPLICATION

This application claims the benefit of U.S. Provisional Application No. 61/501,565 filed Jun. 27, 2011.

### BACKGROUND OF THE INVENTION

This invention is directed toward decorative inflatable systems. More specifically this invention relates to an inflatable receptacle that is inflated utilizing the exhaust from a vehicle.

The phenomenon of tailgate partying has become entrenched in American culture. These pregame festivities usually occur in the parking lot of stadiums and arenas, before and occasionally after games and concerts. Tailgate culture has even spread to events such as weddings and other non-sports related gatherings. The practice of tailgating has been described as “the last American neighborhood” and tailgate parties as “the new American community.” The phenomenon of tailgating has become so mainstream in American culture that major sports media have employed tailgate-like settings for use by their host and commentators (complete with festive fans surrounding the broadcast area).

Manufacturers have responded to the tailgating phenomenon with a variety of innovative “tailgating gear” products, ranging from vehicle mounted grills and coolers to games and furnishings. Participants in the tailgating community crave high visibility in order to be easily located within a mass of parked vehicles. Currently, whimsical decorations are used for visibility and sheer entertainment value, often demonstrating support for the tailgaters' favorite sports team.

Still problems remain. In particular, many times the whimsical decorations are cardboard cutouts or other paraphernalia that is difficult to haul or carry, can easily be broken or simply is not large enough to attract attention to the tailgating area. In addition anchoring such items to ensure that they do not blow away can be difficult and time consuming.

Currently in the art inflatable receptacles exist that are used as lawn ornaments. Often during Christmas season you can see an inflatable Santa that has indicia causing the inflatable receptacle to appear as Santa Claus in the front yard of individuals. Such inflatable receptacles typically have an air moving device that continually provides moving air within the receptacle in order to keep the receptacle inflated. Typically such air moving devices are powered by electricity and are required to be plugged into an electrical outlet. Thus, such inflatable receptacles have typically only been useful as lawn ornaments and are incompatible with tailgating due to the lack of access to an electrical outlet.

Additionally, in the past individuals have contemplated utilizing the exhaust from a vehicle as a source of power. In particular a car jack exists that can be connected to the exhaust of a vehicle in order to power the jack to simplify the operation of jacking during the wheel changing process. Still, typically exhaust from a tailpipe is unused and usually expels into the environment without further functional purpose.

Therefore, a principle object of the present invention is to provide an inflatable decorative system that can be used at remote locations.

Yet another object of the present invention is to provide an inflatable decorative system that is easy to transport and operate.

Another object of the present invention is to provide an inflatable decorative system that eliminates the need for an inflating device such as an electrically-powered fan or compressor.

Yet another object of the present invention is to provide an inflatable decorative system that is low cost.

Another object of the present invention is to provide an inflatable decorative system that is light and small.

Yet another object of the present invention is to provide an inflatable decorative system that has countless marketing possibilities.

These and other objects, features, and advantages will become apparent from the specification and claims.

### BRIEF SUMMARY OF THE INVENTION

An inflatable decorative system that includes a vehicle having an exhaust conduit for conveying exhaust from the vehicle. An exhaust conveyance element is sealingly coupled to the exhaust conduit and the inflatable decorative receptacle. Thus, when the vehicle is emitting exhaust from the exhaust conduit the exhaust is conveyed to the inflatable decorative receptacle in order to inflate the inflatable decorative receptacle.

### BRIEF DESCRIPTION OF THE DRAWINGS

FIG. 1 is a perspective view of an inflatable decorative system;

FIG. 2 is a perspective view of an exhaust conveyance element of an inflatable decorative system;

FIG. 3 is a perspective view of an exhaust conduit and exhaust conveyance element of an inflatable decorative system; and

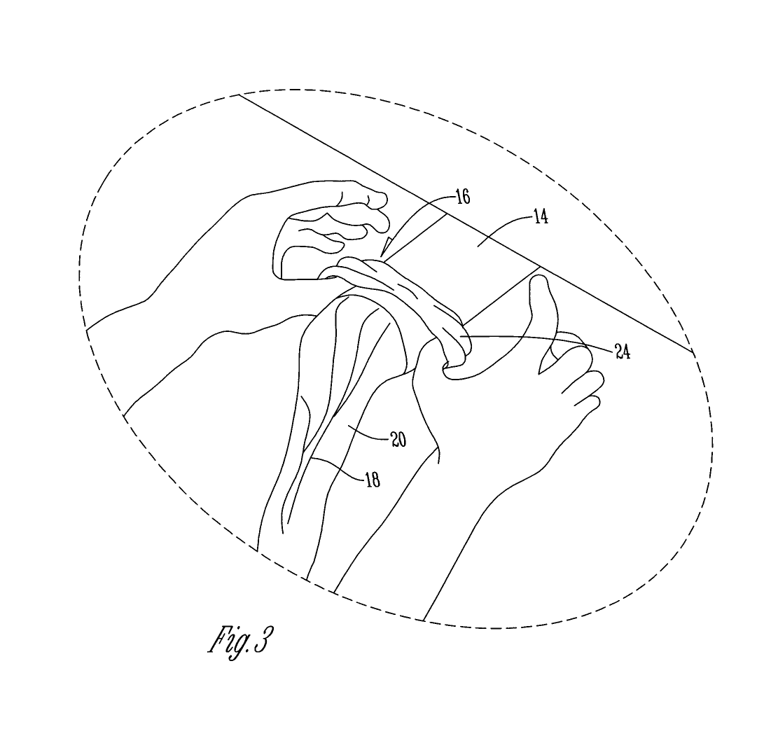

FIG. 4 is a perspective view of a coupling device of an inflatable decorative system.

### DETAILED DESCRIPTION OF THE PREFERRED EMBODIMENT

The figures show an inflatable decorative system 10 that includes a vehicle 12 as is known in the art. The vehicle 12 can be a car, truck, SUV, motorcycle, all-terrain vehicle, semi-truck or the like that contains an exhaust conduit 14 for expelling exhaust from the vehicle 12. A coupling device 16 is utilized to sealingly secure an exhaust conveyance element 18 to the exhaust conduit 14. The coupling device 16 may be an elastic band that surrounds the exhaust conveyance element, a clamp, a string, a drawstring, or the like that applies radial pressure to the exhaust conveyance element 18 and/or exhaust conduit 14 in order to frictionally and sealingly engage the exhaust conduit 14 and exhaust conveyance element 18 to one another. The coupling device 16 is adjustable to accommodate various tailpipe diameters, by any means known in the art such as hose clamp, zip tie, Velcro, elastic bands, or any other means.

The exhaust conveyance element 18 extends from a first end 20 that is coupled to the exhaust conduit 14 with the coupling device 16 to a second end 22. At the first end 20 the exhaust conveyance element 18 has a cuff element 24 that comprises additional fabric that extends radially from the first end 20 of the exhaust conveyance element 18 such that an individual may place their thumbs within the cuff element in order to pull the exhaust conveyance element 18 over the exhaust conduit 14 in order to provide a coupling connection without the individual's thumbs contacting the exhaust conduit 14. In this manner, not touching the exhaust conduit 14 reduces the chance of an individual being burned if the exhaust conduit 14 is still warm from the operation of the vehicle 12.

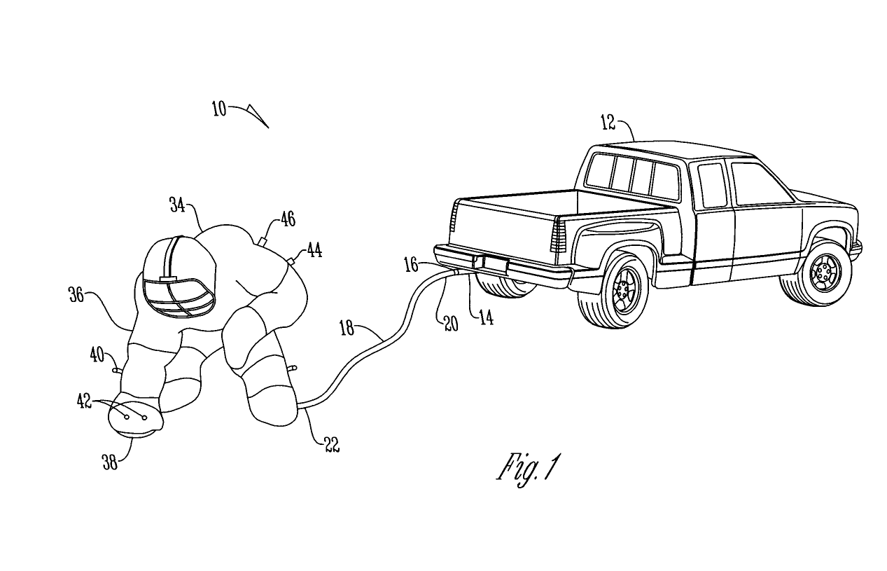

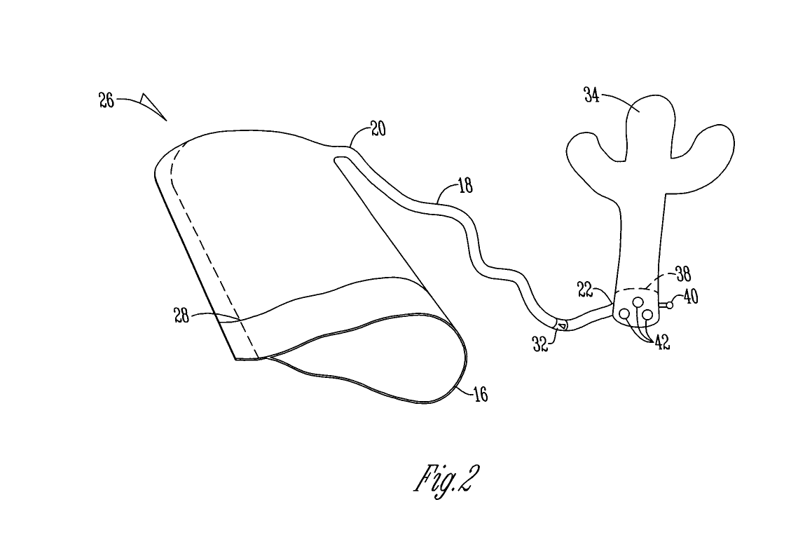

In one embodiment the exhaust conveyance element 18 is a cylindrical tube as shown in FIG. 1. In an alternative embodiment as shown in FIG. 2 the exhaust conveyance element 18 can be a sleeve 26 that is formed by taking a piece of material that is cut into a rectangle and folded lengthwise such that a seam 28 is created. Alternatively, seam 28 is sealed by taping, heat-sealing, welding, adhesive bonding, sewing, or any other means of creating an airtight seal. Optionally, one inch of material can be folded and cuffed at the first end 20 to form the cuff element 24. In either embodiment preferably the material used is both heat resistant and flexible to allow the passage of air while being sufficiently robust to prevent holes or tears. These materials include Mylar®, metalized polyester, coated nylon, coated vinyl, or any other flexible film that is airtight, heat-resistant and flexible while being sufficiently robust to prevent holes or tears. Optionally, a valve element 32 is placed within the exhaust conveyance element 18 that allows the passage of exhaust through the exhaust conveyance element 18 from the first end 20 to the second end 22 and prevents the movement of air from the second end 22 to the first end 20 such that when the vehicle 12 is turned off and exhaust is no longer conveyed through the exhaust conveyance element 18 that exhaust is not redirected into the exhaust conduit 14 of vehicle 12. Valve element 32 is placed at any position along exhaust conveyance element 18, at the vehicle end, at the interface between the decorative receptacle 34 and the exhaust conveyance element 18, or any position therebetween.

An inflatable decorative receptacle 34 is secured sealingly to the second end 22 of the exhaust conveyance element 18. This connection can either occur as a result of the inflatable decorative receptacle 34 and exhaust conveyance element 18 being of continuous one piece construction or alternatively a coupling device, a seam, a seal, or any other connecting member or method can be utilized to provide the attachment. Preferably the inflatable decorative receptacle 34 is made of the same material as the exhaust conveyance element 18 such as Mylar®, metalized polyester, coated nylon, coated vinyl, or any other flexible film that is airtight, heat-resistant and flexible while being sufficiently robust to prevent holes or tears.

The inflatable decorative receptacle 34 contains indicia 36 associated with a sports team or an event. In one embodiment the inflatable decorative receptacle 34 is a large inflatable football player that includes indicia 36 of an individual's favorite team. As an example the inflatable decorative receptacle is over six feet tall. Alternatively the inflatable decorative receptacle 34 can be an inflatable canopy, inflatable furniture, and inflatable gorilla or other animal, inflatable logo, inflatable mascot, inflatable game, inflatable sign, the shape of a product (i.e., can of beer) or the like. The receptacle also may include or be packaged in a package component or the like (i.e., a six pack of beer) that may be sold through a vending device or retail outlet.

The inflatable decorative receptacle may also be useful in environments other than tailgating parties. For example, vehicles used for food or other vending purposes depend on their visibility to passing motorists and pedestrians. After setting up in a parking lot, street corner or fairground, the inflatable decorative receptacles are deployed on the ground or on the roof of a vehicle to attract attention. For example, a hot dog vendor may deploy a large inflated hotdog or even inflatable words such as “HOT DOGS!”. A utility vehicle may inflate a brightly colored sign that reads “CAUTION” or a large inflated arrow to direct traffic around a work area or at an accident to identify an emergency condition exists. The receptacle may be disposable or reusable.

The inflatable decorative receptacle 34 additionally has at least one compartment 38 for receiving a ballast material such as water, a cooler, or the like in order to anchor the inflatable decorative receptacle 34 to the ground. In an alternative embodiment the inflatable decorative receptacle 34 has grommets 40 that can be utilized in association with a stake or a plurality of stakes in order to secure the inflatable decorative receptacle 34 to the ground. Or alternatively, the inflatable decorative receptacle 34 has an extra piece of material that extends from a portion of its body near the ground that that an object such as a cooler or car tire can be placed on top so as to anchor the system 10 to the ground. An inflatable decorative receptacle 34 additionally has fastening elements 42 that allow the receptacle 34 to be attached and secured to the vehicle 12 or other structure. The fastening elements 42 can include magnets, suction cups, grommets, flexible bands, guy lines, tethers and the like that allow the inflatable decorative receptacle 34 to be secured to a structure or vehicle 12.

In addition, the inflatable decorative receptacle 34 has a pressure relief valve 44 that releases exhaust from within the receptacle 34 when a predetermined pressure within the receptacle is reached to prevent stretching of the material or popping of the inflatable decorative receptacle 34. The inflatable decorative receptacle 34 also has an air release valve 46 that is actuated to release the exhaust from within the inflatable decorative receptacle 34 once the receptacle is no longer in use.

In operation the inflatable decorative receptacle 34 contains no air therein and is easily folded up and packaged into a vehicle 12 for transportation to a tailgating event. Once at the tailgating event the inflatable decorative receptacle 34 can be taken from a package and rolled out and anchored to the ground or mounted on the vehicle or another structure using the compartment 38 or grommets 40, or the fastening elements 42. The fastening elements 42 are also utilized to fasten the receptacle 34 to the vehicle 12 or other structure or both. An individual then places their thumbs into the cuff element 24 in order to place the exhaust conveyance element 18 onto and in communication with the exhaust conduit 14 of the vehicle 12. This preferably is done with the vehicle turned off. The coupling device 16 is then attached to ensure that a sealing secure connection between the exhaust conduit 14 and exhaust conveyance element 18 is provided. In an embodiment where an exhaust conveyance element 18 is not of one-piece construction with the inflatable decorative receptacle 34 the exhaust conveyance element 18 is coupled to the inflatable decorative receptacle 34 at this time.

Once the inflatable decorative receptacle 34 is in communication with the exhaust conduit 14 via the exhaust conveyance element 18 the vehicle 12 is turned on in order to begin conveying exhaust from the exhaust conduit 14 to the inflatable decorative receptacle 34. Once filled, element 32 maintains inflatable decorative receptacle 334 in a filled state. Alternatively, a clamping mechanism 35, such as an industrialized paperclip, clothes pin, clamp, binder clip or the like, is used to seal, pinch, fold-and-pinch or otherwise to form an airtight seal for the inflatable decorative receptacle 34. In this way, gasses within the inflatable decorative receptacle 34 are prevented from traveling back down the exhaust conveyance element 18 which maintains the inflatable decorative receptacle 34 in a fully inflated state. Alternatively, for a one-time-use, disposable inflatable, the user may simply tie a knot in the exhaust conveyance element 18 in order to form an airtight seal for the inflatable decorative receptacle 34.

As the inflatable decorative receptacle 34 receives the exhaust the receptacle 34 inflates to present a large inflatable decorative receptacle 34 that in one embodiment has the indicia of that individual's team. In this manner the inflatable decorative receptacle 34 is easily seen from all different places of the tailgate party so that a person can be quickly located.

Once the inflatable decorative receptacle 34 is full preferably, an individual may turn off the vehicle 12 and the valve element 32 prevents the exhaust from being conveyed back through the exhaust conveyance element 18 to the exhaust conduit 14. In this manner the inflatable decorative receptacle 34 stays inflated without the need of additional exhaust. In addition, if too much exhaust is placed into the inflatable decorative receptacle 34 the pressure relief valve 44 releases the pressure to prevent destruction of the inflatable decorative receptacle 34 through over inflation.

Once the inflatable decorative receptacle 34 no longer needs to be used the air release valve 46 is actuated to release the exhaust from within the receptacle 34. Alternatively, the clamping mechanism used to seal or fold-and-pinch the exhaust conveyance element 18 is removed to allow the escape of exhaust gases. Alternatively, for a one-time-use, disposable inflatable decorative receptacle 34, the use may simply pierce or cut the inflatable decorative receptacle 34 to allow the escape for exhaust gasses, then dispose of the deflated material in a waste receptacle. The receptacle 34 may then be rolled up or folded and easily stored within the vehicle 12 for its next use or thrown away.

Because the system presented is extremely light, extremely small (when in an un-inflated state) extremely inexpensive and disposable, this system lends itself well to a countless variety of creative marketing opportunities never before seen. The system can easily be sold in stores on racks alongside other tailgating supplies. The system can be placed inside the package of other tailgating supplies for promotional purposes. The system can be sold in vending machines or by vendors located near tailgating locations. As one example the system can be placed within a case of beer, and can contain cross-promotional indicia, such as the name of the product, or be designed in the likeness of the product in which it was packaged. As another example, the system can be placed within a can of beer.

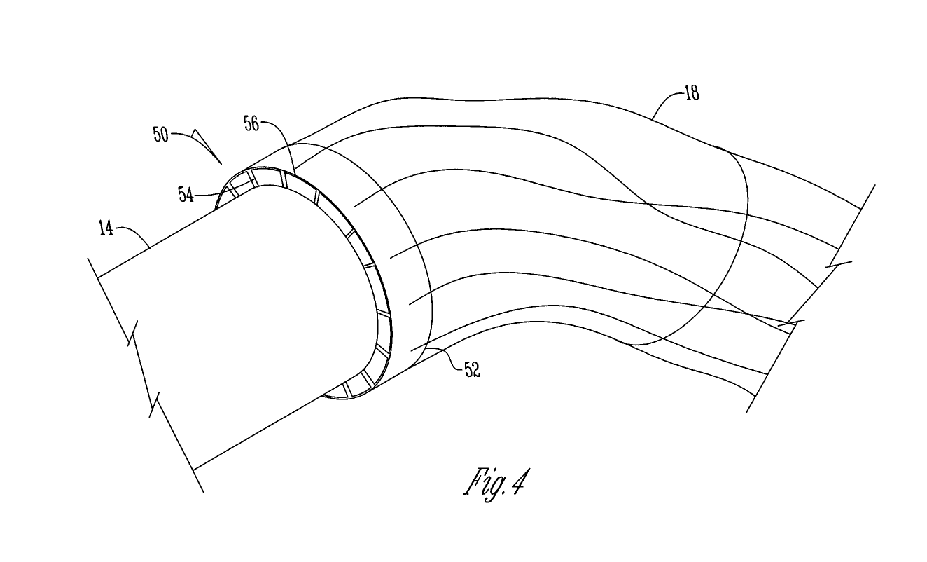

With reference to FIG. 4, an improved coupling mechanism 50 is presented. Many potential decorative receptacle materials may not be able to withstand the heat or pressure of exhaust. In addition, the back pressure caused by the system 10 on the exhaust system of vehicle 12, while minimal, has the potential to cause wear or damage. The improved coupling mechanism 50 resolves these issues by securing the exhaust conveyance element 18 to the exhaust conduit 14 in a non-air-tight manner. This design incorporates a ventilating disk 52. One end ventilating disk 52 is removably and replaceably attached to the end of exhaust conduit 14. On the other end ventilating disk 52 is fluidly connected to exhaust conveyance element 18. Ventilating disk 52 is made of a heat resistant material, so that it can withstand being attached directly to the exhaust conduit 14. The ventilating disk 52 is variable in size so as to adjustably fit various sized and shaped exhaust conduits 14.

Ventilating disk 52 is not connected to exhaust conduit in an air-tight, surface-to-surface seal. Instead, ventilating disk 52 has a plurality of ribs 54 that create a plurality of through holes 56 positioned around the circumference of ventilating disk 52. These through holes 56 exploit the principle of fluid dynamics known as “Bernoulli's Principle” wherein when exhaust gasses pass through improved coupling device 50, air from the surrounding environment is pulled through the through holes 56. This air has the effect of cooling the exhaust gasses and diluting any corrosive or toxic gases. In addition, in an over-fill condition, the trough holes 56 allow for exhaust gasses to escape there through, which prevents destruction of the decorative receptacle 34 or an overheating condition of the vehicle 12.

Thus provided is an inflatable decorative system 10 that utilizes the exhaust from a vehicle 12 in order to inflate an inflatable decorative receptacle 34. In this manner the inflatable decorative receptacle 34 can be easily stored and transferred to and from tailgating events, without the necessity of purchasing and transporting a separate inflating device such as an electrically-powered fan or compressor. Because of the size, shape and indicia 36 of the inflatable decorative receptacle 34 the receptacle 34 is easily spotted by individuals and draws attention to the individual having the inflatable decorative receptacle 34. This causes other individuals to talk and socially communicate with the individual about their receptacle 34. Further, by having safety devices such as the cuff element 24, valve element 32, and the pressure release valve 44 provides a minimal chance that an individual is injured utilizing the receptacle 34 or that the receptacle 34 is damaged. Thus, at the very least all of the stated objectives have been met.

It will be appreciated by those skilled in the art that other various modifications could be made to the device without departing from the spirit and scope of this invention. All such modifications and changes fall within the scope of the claims and are intended to be covered thereby.

What is claimed is:

1. An inflatable decorative system comprising:
a vehicle having an exhaust conduit for conveying exhaust from the vehicle;
an exhaust conveyance element sealingly coupled to the exhaust conduit and in fluid communication with an inflatable decorative receptacle to provide a fluid communication path between the exhaust conduit and inflatable decorative receptacle;
wherein when the vehicle is emitting exhaust from the exhaust conduit the exhaust is conveyed to the inflatable decorative receptacle to inflate the inflatable decorative receptacle.

2. The system of claim 1 wherein the exhaust conveyance element is a tube.

3. The system of claim 1 wherein the exhaust conveyance element is a sleeve having a seam.

4. The system of claim 1 wherein the exhaust conveyance element is made of metalized polyester film.

5. The system of claim 1 wherein the exhaust conveyance element is made of flexible airtight film.

6. The system of claim 1 wherein the exhaust conveyance element has a cuff at a first end that extends over the exhaust conduit.

7. The system of claim 1 wherein the exhaust conveyance element is sealingly coupled to the exhaust conduit with an elastic band that surrounds the exhaust conveyance element.

8. The system of claim 1 wherein the exhaust conveyance element connects to the exhaust conduit by a coupling device that is adjustable in size.

9. The system of claim 1 wherein the exhaust conveyance element connects to the exhaust conduit by a coupling device that has through holes therein.

10. The system of claim 1 wherein the exhaust conveyance element has a valve disposed therein to prevent air and exhaust from being conveyed from the inflatable decorative receptacle to the exhaust conduit.

11. The system of claim 1 wherein the inflatable decorative receptacle has indicia associated with a sport's team.

12. The system of claim 1 wherein the inflatable decorative receptacle is flexible.

13. The system of claim 1 wherein the inflatable decorative receptacle is a canopy.

14. The system of claim 1 wherein the inflatable decorative receptacle is inflatable furniture.

15. The system of claim 1 wherein the inflatable decorative receptacle has fastening elements for attaching to the vehicle.

16. The system of claim 12 wherein the fastening elements are suction cups.

17. The system of claim 1 wherein the inflatable decorative receptacle has grommets through which stakes are disposed to secure the decorative receptacle to the ground.

18. The system of claim 1 wherein the inflatable decorative receptacle has a compartment to be filled with ballast materials to anchor the inflatable decorative receptacle to the ground.

19. The system of claim 1 wherein the exhaust conveyance element the inflatable decorative receptacle are of continuous one piece construction.
